(19) United States
(12) Patent Application Publication
(10) Pub. No.: US 2026/0110249 A1
(43) Pub. Date: Apr. 23, 2026

(54) SUSPENDED DRILLING AND BOLT MOUNTING SYSTEM

(71) Applicant: LENOVO NEW VISION (JIANGSU) EQUIPMENT SERVICE CO., LTD, Yancheng (CN)

(72) Inventors: Yanjin ZHU, Yancheng (CN); Yishan CHEN, Yancheng (CN); Yutao ZHANG, Yancheng (CN)

(73) Assignee: LENOVO NEW VISION (JIANGSU) EQUIPMENT SERVICE CO., LTD, Yancheng (CN)

(21) Appl. No.: 19/426,167

(22) Filed: Dec. 19, 2025

Related U.S. Application Data
(63) Continuation of application No. PCT/CN2024/090296, filed on Apr. 28, 2024.

(30) Foreign Application Priority Data
Jun. 21, 2023 (CN) 202310740166.6

(51) Int. Cl. E21D 20/00

(52) U.S. Cl. CPC E21D 20/003

(57) ABSTRACT

Provide is a suspended drilling and bolt mounting system including a main frame. Slings are arranged on the main frame, two supporting mechanisms are arranged on two sides of the main frame in a length direction, respectively, for limiting a shaking amplitude of the main frame in a lifting process, and further fixing a position of the main frame during drilling and bolt mounting of the suspended drilling and bolt mounting system, a wall supporting mechanism matched with a side wall of a shaft is arranged on a side, close to a to-be-machined surface, of the main frame, a drilling and bolt mounting mechanism is arranged below the main frame, and a driving mechanism used for driving the drilling and bolt mounting mechanism to move along an X-axis, move along a Y-axis, and rotate along a Z-axis is arranged between the main frame and the drilling and bolt mounting mechanism.

### CROSS-REFERENCE TO RELATED APPLICATIONS

This application is a continuation of International Patent Application No. PCT/CN2024/090296, filed on April 28, 2024, which claims priority of Chinese Patent Application No. 202310740166.6, filed on June 21, 2023, the entire contents of each of which are incorporated herein by reference.

### TECHNICAL FIELD

The present disclosure relates to the technical field of shaft drilling apparatuses, and in particular, to a suspended drilling and bolt mounting system.

### BACKGROUND

Shaft drilling, as the name implies, refers to drilling holes in a channel extending in a vertical direction. The shaft refers to a space for a lifting apparatus to operate. A hole is drilled in the shaft and an expansion bolt is inserted into an inner wall of the shaft, so that a bracket (e.g., a guide rail bracket required for the lifting apparatus) can be subsequently fixed to the inner wall of the shaft, to provide stability for the lifting movement of the lifting apparatus operating in the shaft.

According to an existing shaft drilling apparatus, a winch usually works with a sling to drive the drilling apparatus to move in the shaft. Because of a large shaking amplitude of the sling during a descending process, the efficiency and hole position precision of drilling a side wall of the shaft are affected. This leads to a large deviation in an orientation and a position of the subsequently inserted bolt, further affecting subsequent fixation of the bracket, thereby presenting security risks in the lifting movement of the lifting apparatus.

### SUMMARY

The present disclosure provides a suspended drilling and bolt mounting system, to overcome the problem in the prior art that, the shaking amplitude is large during a movement of a drilling apparatus in a shaft, which affects the efficiency and hole position precision of drilling a side wall of the shaft and thereby deviating the position and orientation of the bolt subsequently inserted therein.

One or more embodiments of the present disclosure provide a suspended drilling and bolt mounting system, including a main frame, where a plurality of slings used for controlling lifting of the main frame are arranged above the main frame, two supporting mechanisms are arranged on two sides of the main frame in a length direction, respectively, the two supporting mechanisms are used for limiting a shaking amplitude of the main frame in a lifting process, the two supporting mechanisms are further used for fixing a position of the main frame during drilling and bolt mounting of the suspended drilling and bolt mounting system, a wall supporting mechanism matched with a side wall of a shaft is arranged on a side, close to a to-be-machined surface, of the main frame, a drilling and bolt mounting mechanism is arranged below the main frame, and a driving mechanism used for driving the drilling and bolt mounting mechanism to move along an X-axis, move along a Y-axis and rotate along a Z-axis is arranged between the main frame and the drilling and bolt mounting mechanism.

To prevent excessive shaking of the suspended drilling and bolt mounting system (hereinafter referred to as “the system”) in the shaft, the two supporting mechanisms are matched with two side walls arranged opposite to the shaft, on one hand, when the system moves up and down in the shaft, the shaking amplitude of the system in the shaft is reduced, and on the other hand, when the system drills holes and installs bolt on the side walls of the shaft, the supporting mechanisms are pressed against the side walls of the shaft to fix the main frame, and the stability during drilling and bolt mounting is guaranteed. The wall supporting mechanism works on the to-be-machined surface, so that the system is more stable when moving up and down in the shaft, and a position of the system during the operation of the counterweight is more accurate. The two supporting mechanisms, the wall supporting mechanism, the drilling and bolt mounting mechanism, and the driving mechanism operate with each other to drill the to-be-machined surface and install the bolt into the hole, so as to ensure that the drilled hole is perpendicular to the side walls of the shaft.

In some embodiments, each of the two supporting mechanism includes an intermediate plate and a floating plate, the floating plate is arranged on one side of the intermediate plate away from the main frame, a middle position of the floating plate is hinged to the intermediate plate along a vertical direction, a limiting spring used for limiting a swing amplitude of the floating plate is arranged on the intermediate plate, the limiting spring is arranged between the floating plate and the intermediate plate, a plurality of supporting claws are arranged at two ends of a side wall of the floating plate away from the intermediate plate, a supporting wheel is arranged above or below each of the plurality of supporting claws, an elastic component is arranged between the supporting wheel and the floating plate, under driving of the elastic component, a projection of the supporting wheel in the vertical direction is on an outer side of a projection of the plurality of supporting claws in the vertical direction, and the main frame is provided with an electric push rod used for pushing intermediate plates of the two supporting mechanisms towards two sides of the main frame.

The intermediate plates on the two supporting mechanisms are pushed out towards the two sides by the electric push rod, so that the intermediate plates are close to the two opposite side walls of the shaft, therefore the supporting wheel and the supporting claws are driven to get close to the two side walls of the shaft. Since under the driving of the elastic component, the projection of the supporting wheel in the vertical direction is on the outer side of the projection of the supporting claws in the vertical direction, when the supporting wheel is in contact with the side wall of the shaft, the supporting claws are not in contact with the side wall of the shaft. Through the action of the elastic component, the supporting wheel is elastic in contact with the side wall of the shaft, so that the system runs freely up and down in the shaft is guaranteed, and meanwhile, the shaking amplitude of the system in the shaft is reduced. When the system reaches the drilling position, the electric push rod continues to drive the intermediate plates to be close to the two side walls of the shaft, and the supporting claws are in contact with the side wall of the shaft, so that the system can be stably supported guaranteed, and the drilling stability is guaranteed.

In some embodiments, the intermediate plate and the floating plate are both U-shaped plates, an inner diameter of the floating plate is larger than an outer diameter of the intermediate plate, the intermediate plate partially extends into a U-shaped groove of the floating plate, a U-shaped connecting frame is arranged on an outer side of the intermediate plate, and a connecting pin matched with the floating plate is vertically arranged in the U-shaped connecting frame. The side wall of the shaft may be uneven, and the side walls arranged oppositely are not be absolutely parallel, the intermediate plate and the floating plate enable the supporting wheel/supporting claws to be tightly attached to the side wall of the shaft.

In some embodiments, at least one sleeve assembly is arranged on the main frame, the sleeve assembly includes a sliding rod and a sliding sleeve, an axis of the sliding rod and an axis of the sliding sleeve are parallel to an axis of the electric push rod, the sliding rod is slidably connected to two ends of the sliding sleeve, and one end of the sliding rod away from the sliding sleeve is fixedly connected to the intermediate plate on one of the two supporting mechanisms. The sleeve assembly can improve stability of connection between the supporting mechanisms and the main frame.

In some embodiments, the wall supporting mechanism includes two wall supporting wheel assemblies arranged at intervals, each of the two wall supporting wheel assemblies includes an L-shaped frame and a wall supporting wheel, one end of the L-shaped frame is rotatably connected to the wall supporting wheel, the other end of the L-shaped frame is rotatably connected to the main frame along a horizontal direction, and a height of a rotation center of the wall supporting wheel is lower than a height of a rotation center about which the L-shaped frame rotates relative to the main frame.

The wall supporting wheel is arranged on the side of the main frame close to the to-be-machined surface, and the wall supporting wheel is rotationally connected to the main frame by the L-shaped frame, so that the wall supporting wheel can freely rotate by 360 degrees. The wall supporting wheel is vertically arranged under the action of gravity and is matched with the to-be-machined surface, so as to ensure that the drilling position of the system during the operation of the counterweight is more accurate.

In some embodiments, the drilling and bolt mounting mechanism includes a machine frame and a drill and a knocking hammer arranged on the machine frame, an axis of an output end of the drill and an axis of an output end of the knocking hammer are parallel to each other and arranged in opposite directions.

In some embodiments, the driving mechanism includes a first sliding rail, a second sliding rail, and a rotating shaft, the first sliding rail is arranged below the main frame along the X-axis, a first sliding block is slidably connected to the first sliding rail, a first lead screw and a first motor are arranged at one side of the first sliding rail for driving the first sliding block to slide back and forth along the X-axis, the second sliding rail is arranged at a lower end of the first sliding block along the Y-axis, a second sliding block is slidably connected to the second sliding rail, a second lead screw and a second motor are arranged at one side of the second sliding rail for driving the second sliding block to move back and forth along the Y-axis, the rotating shaft is arranged along the Z-axis, an upper end of the rotating shaft is rotatably connected to the second sliding block, a lower end of the rotating shaft is rotatably connected to the machine frame, and the second sliding block is in transmission connection with a third motor used for controlling the machine frame to rotate along the rotating shaft.

In some embodiments, a rebar detector is arranged on the machine frame, and the rebar detector is provided with a lead screw motor assembly used for controlling the rebar detector to move back and forth along the Z-axis. A height of the rebar detector is adjusted by the lead screw motor assembly, the rebar detector detects a position height of the rebar in the to-be-machined surface, and matches with the slings used for controlling the height of the main frame, so that the drill is enabled to drill at a position without a rebar.

In some embodiments, a bolt feeding assembly is arranged on one side of the second sliding rail away from a to-be-machined surface, the bolt feeding assembly includes a sprocket and a chain, a rotation center of the sprocket is arranged along the horizontal direction, the chain is wound on the sprocket, a plurality of feeding units are arranged on an outer wall surface of the chain at intervals, each of the plurality of feeding unit includes two bolt clamping plates which are oppositely arranged, each of a plurality of bolts is clamped at an inner axial position defined by the two bolt clamping plates, and an axis of each of the plurality of bolts is parallel to an axis of the sprocket, a magnet is disposed between the two bolt clamping plates of each of the plurality of feeding units for attracting one of the plurality of bolts, a feeding in-place switch is arranged on one side of a highest point of the sprocket for monitoring one of the plurality of bolts, and a material shifting assembly is arranged on one side of the feeding in-place switch for shifting one of the plurality of bolts out of the two bolt clamping plates so that the knocking hammer is capable of grabbing the plurality of bolts.

One bolt is manually placed in each feeding unit in advance, the bolt is fixed by the two bolt clamping plates and the magnet, the highest point of the sprocket is used as a feeding point, and the chain is driven to rotate along a fixed direction by the sprocket, so that the bolt is supplied. The feeding in-place switch is an infrared sensor, and when the feeding in-place switch detects the bolt, the feeding motor of the sprocket stops rotating. The material shifting assembly is used for shifting the bolt out of the bolt clamping plates and away from the magnet, facilitating the knocking hammer to grab the bolt, and completing feeding. The operation is repeated, and the bolt can be automatically fed.

In some embodiments, the material shifting assembly includes two material shifting plates arranged in parallel and a material shifting motor, an axis of an output end of the material shifting motor is parallel to the axis of the sprocket, the two material shifting plates are arranged at the output end of the material shifting motor, the two material shifting plates are arranged at two sides of the sprocket, respectively, and each of the two material shifting plates is provided with an arc-shaped groove matched with the plurality of bolts. The material shifting assembly can shift the bolt out of the bolt clamping plates.

In some embodiments, one side of the material shifting motor is provided with a material shifting initial position switch and a material shifting in-place switch, when one of the two material shifting plates is in contact with the material shifting initial position switch, the arc-shaped groove is arranged below the feeding in-place switch, and when one of the two material shifting plates is in contact with the material shifting in-place switch, the arc-shaped groove is arranged above the feeding in-place switch. The material shifting initial position switch and the material shifting in-place switch can control a movement range of the material shifting plates.

The material shifting initial position switch and the material shifting in-place switch are microswitches, and the material shifting plate is in contact with the microswitches to confirm whether the material shifting plate is rotated in place or not, so that the material shifting motor is powered off in time.

In some embodiments, the suspended drilling and bolt mounting system further includes a measuring mechanism, where the measuring mechanism includes a plurality of distance sensors, a controller, and a laser plummet arranged on the main frame, and the plurality of distance sensors, the laser plummet, the first motor, the second motor and the third motor are all in circuit connection with the controller.

The laser plummet is used for detecting whether the system is in the counterweight status. The system operates together with the slings by the winch, so that the whole drilling and bolt mounting system is in a counterweight status, guaranteeing that the system is always perpendicular to the ground under the action of the winch and the slings (e.g., keeping the rotating shaft of the driving mechanism perpendicular to a bottom surface of the shaft.). In the counterweight status, the distance between the system and the side wall of the shaft is measured by the plurality of distance sensors, then the supporting claws are extended out to lock the position of the main frame, and in this case, the distance between the system and the side wall of the shaft is measured again, and then a difference between the second measurement and the first measurement is calculated to be compensated to the drilling position, so as to ensure a precise drilling position.

In the suspended drilling and bolt mounting system provided by the present disclosure, the supporting mechanisms, the wall supporting mechanism, the driving mechanism, and the drilling and bolt mounting mechanism are arranged on the main frame to operate together, and when the system is in the counterweight status, a hole position perpendicular to the side wall of the shaft is drilled on the side wall, so that a position of a bolt driving into the hole position is accurate, the structural strength of a bracket fixed to the side wall of the shaft is guaranteed, and the stability of a lifting apparatus in lifting movement is guaranteed.

### BRIEF DESCRIPTION OF THE DRAWINGS

The present disclosure will be further described in conjunction with the accompanying drawings and embodiments.

FIG. 1 is a schematic structural diagram of a suspended drilling and bolt mounting system of the present disclosure;

FIG. 2 is an enlarged view of A in FIG. 1;

FIG. 3 is a schematic structural diagram of a supporting mechanism;

FIG. 4 is a schematic structural diagram of a suspended drilling and bolt mounting system of the present disclosure;

FIG. 5 is a schematic structural diagram of a bolt feeding assembly;

FIG. 6 is a front view of a bolt feeding assembly;

FIG. 7 is a side view of a bolt feeding assembly;

FIG. 8 is a schematic structural diagram of a material shifting assembly; and

FIG. 9 is a schematic structural diagram of a drilling and bolt mounting mechanism.

In the figures: 1. main frame, 2. drilling and bolt mounting mechanism, 2-1. machine frame, 2-2. drill, 2-3. knocking hammer, 3. sling, 4. intermediate plate, 5. floating plate, 6. supporting claw, 7. supporting wheel, 8. elastic component, 9. connecting pin, 10. limiting spring, 11. electric push rod, 12. sliding rod, 13. sliding sleeve, 14. L-shaped frame, 15. wall supporting wheel, 16. first sliding rail, 17. second sliding rail, 18. first sliding block, 19. second sliding block, 21. rebar detector, 22. sprocket, 23. chain, 24. bolt clamping plate, 25. magnet, 26. bolt, 27. feeding in-place switch, 28. material shifting plate, 28-1. arc-shaped groove, 29. material shifting motor, 30. material shifting initial position switch, 31. material shifting in-place switch, 32. distance sensor, 33. laser plummet, 34. feeding motor.

### DETAILED DESCRIPTION

The present disclosure will now be described in detail with reference to the accompanying drawings. The figure is a simplified schematic diagram illustrating a basic structure of the present disclosure in a schematic manner only, and therefore, the figure only displays a composition related to the present disclosure.

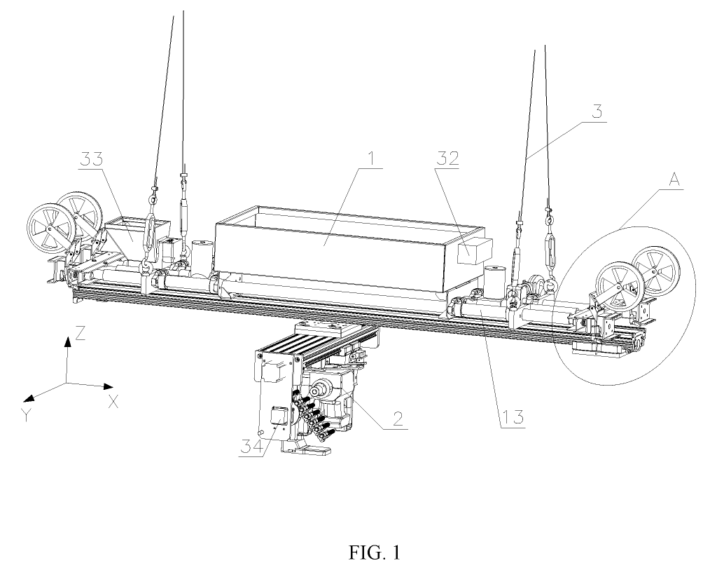

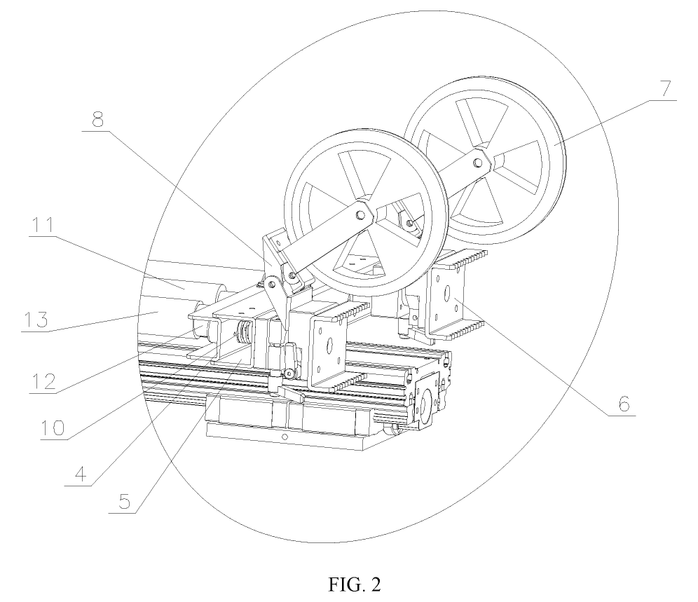

FIG. 1 is a schematic structural diagram of a suspended drilling and bolt mounting system of the present disclosure; and FIG. 2 is an enlarged view of A in FIG. 1.

As shown in FIG. 1 to FIG. 2, in the present disclosure, the suspended drilling and bolt mounting system (hereinafter referred to as “the system”) includes a main frame 1, where a plurality of slings 3 used for controlling lifting of the main frame 1 are arranged above the main frame 1, two supporting mechanisms are arranged on two sides of the main frame 1 in a length direction, respectively, the two supporting mechanisms are used for limiting a shaking amplitude of the main frame 1 in a lifting process, the two supporting mechanisms are further used for fixing a position of the main frame 1 during drilling and bolt mounting of the system, a wall supporting mechanism matched with a side wall of a shaft is arranged on a side, close to a to-be-machined surface, of the main frame 1, a drilling and bolt mounting mechanism 2 is arranged below the main frame 1, and a driving mechanism used for driving the drilling and bolt mounting mechanism 2 to move along an X-axis, move along a Y-axis, and rotate along a Z-axis is arranged between the main frame 1 and the drilling and bolt mounting mechanism 2.

The main frame 1 refers to a frame structure for carrying the system. The main frame 1 can ensure operational stability and load-bearing capacity.

The slings 3 may be connected to the main frame 1 via connecting members (e.g., wire rope clips), with opposite ends (i.e., the ends away from the main frame 1) of the slings 3 connected to a lifting apparatus (e.g., a winch or an electric hoist) to control the system to be lifted or lowered along a vertical direction to a predetermined height.

As shown in FIG. 1, an orthogonal coordinate system is adopted for the X-axis, Y-axis, and Z-axis, where the Z-axis is the vertical direction (i.e., the lifting/lowering direction of the system), and the Y-axis is a horizontal direction.

The two supporting mechanisms are used to prevent the main frame 1 from experiencing significant shaking during the lifting and lowering process. The two supporting mechanisms may be respectively disposed at two ends of a major axis of the main frame 1. Each supporting mechanism is capable of contacting a side wall of the shaft and providing cushioning. The major axis of the main frame 1 is parallel to the X-axis. For example, when the system is lowered or raised via the plurality of slings 3, the supporting wheels 7 of the supporting mechanisms abut against the side walls of the shaft. The elastic component 8 inside the supporting wheel 7 provides a certain degree of elastic cushioning, thereby reducing the shaking amplitude during the lifting and lowering process.

In some embodiments, each of the two supporting mechanisms further has a position locking function. The position locking function may fix the main frame 1 during the drilling and bolt mounting operation of the system. The position locking function of the supporting mechanism may be achieved in various ways. For example, retractable pneumatic or hydraulic support rods may be used to fix against the side walls of the shaft.

The wall supporting mechanism is used to guide the main frame 1 to move smoothly along the side walls of the shaft during the lifting and lowering process of the system. The wall supporting mechanism provides initial stable contact, preventing collision between the main frame 1 and the to-be-machined surface. The to-be-machined surface refers to a side wall within the side walls of the shaft where holes are to be drilled and bolts mounted. The side wall of the shaft in contact with the wall supporting mechanism (i.e., the to-be-machined surface) and the side wall of the shaft in contact with the supporting mechanism are perpendicular or approximately perpendicular to each other.

In some embodiments, the specific structure of the wall supporting mechanism may vary. For example, the wall supporting mechanism may be a guide plate with a buffer spring.

The drilling and bolt mounting mechanism is used for drilling holes on the to-be-machined surface and installing bolts into the holes. For example, the drilling and bolt mounting mechanism includes an impact drill.

The driving mechanism may include a plurality of motors, a plurality of lead screws, and a plurality of sliding blocks. The driving mechanism may adopt a transmission method from a motor to a lead screw to a sliding block to transmit power to the drilling and bolt mounting mechanism 2 to achieve movement and rotation.

The suspended drilling and bolt mounting system provided by some embodiments of the present disclosure enhances the degree of automation and operational efficiency for work at height or in confined spaces (e.g., shafts) through the supporting mechanisms, the wall supporting mechanism, the driving mechanism, and the drilling and bolt mounting mechanism. The system can effectively suppress shaking during lifting and lowering and achieve precise fixation during drilling and bolt mounting, ensuring the perpendicularity of the holes and the accuracy of installation.

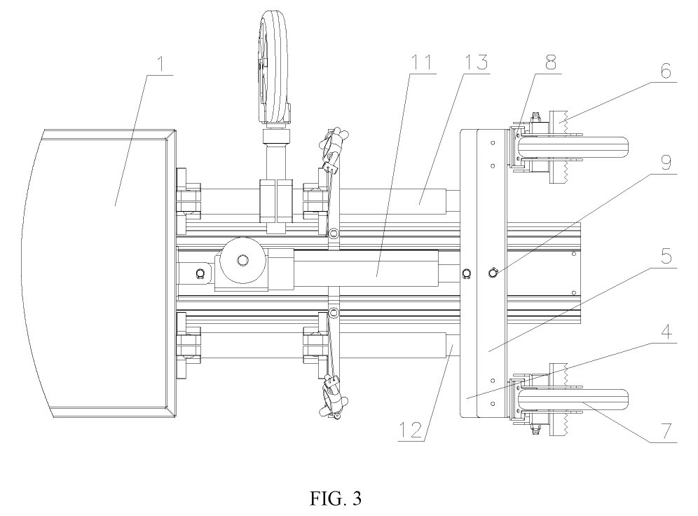

FIG. 3 is a schematic structural diagram of a supporting mechanism. As shown in FIG. 2 to FIG. 3, each of the two supporting mechanisms includes an intermediate plate 4 and a floating plate 5. The floating plate 5 is arranged on one side of the intermediate plate 4 away from the main frame 1. A middle position of the floating plate 5 is hinged to the intermediate plate 4 along the vertical direction. A limiting spring 10 used for limiting a swing amplitude of the floating plate 5 is arranged on the intermediate plate 4. The limiting spring 10 is arranged between the floating plate and 5 the intermediate plate 4. A plurality of supporting claws 6 are arranged at two ends of a side wall of the floating plate 5 away from the intermediate plate 4. A supporting wheel 7 is arranged above or below each of the plurality of supporting claws 6. An elastic component 8 is arranged between the supporting wheel 7 and the floating plate 5. The elastic component 8 is an elastic hinge, under driving of the elastic component 8, a projection of the supporting wheel 7 in the vertical direction is on an outer side of a projection of the plurality of supporting claws 6 in the vertical direction. The main frame 1 is provided with an electric push rod 11 used for pushing the intermediate plates 4 of the two supporting mechanisms towards two sides of the main frame 1.

“Hinged along the vertical direction” refers to a hinge axis being parallel to the Z-axis, allowing the floating plate 5 to swing about the hinge axis within an XY plane. That is, the floating plate 5 may swing between a position parallel to the intermediate plate 4 and a position not parallel to the intermediate plate 4.

The axis of the limiting spring 10 may be parallel to the X-axis. For example, the limiting spring 10 may be a helical spring, with one end connected to the floating plate 5 and the other end connected to the intermediate plate 4. It limits excessive swing of the floating plate 5 through an elastic force and provides a cushioning effect. The limiting spring 10 may be disposed near an end of the intermediate plate 4 along a length direction of the intermediate plate 4.

In some embodiments, the intermediate plate 4 and the floating plate 5 are both U-shaped plates, an inner diameter of the floating plate 5 is larger than an outer diameter of the intermediate plate 4, the intermediate plate 4 partially extends into a U-shaped groove of the floating plate 5, a U-shaped connecting frame is arranged on an outer side of the intermediate plate 4, and a connecting pin 9 matched with the floating plate 5 is vertically arranged in the U-shaped connecting frame. The floating plate 5 is the U-shaped connecting frame.

The axis of the connecting pin 9 is parallel to the Z-axis. The floating plate 5 is movably connected to the connecting pin 9, allowing the floating plate 5 to swing. The inner diameter of the floating plate 5 refers to a groove width of the U-shaped groove, and the outer diameter of the intermediate plate 4 refers to a width of the U-shaped plate.

The side wall of the floating plate 5 away from the intermediate plate 4 refers to an outermost wall of the floating plate 5. “Inner side” refers to a side closer to a center of the main frame 1, and “outer side” refers to a side farther from the center of the main frame 1. The outer side of the supporting claws 6 is provided with toothed features to increase friction when ultimately contacting the shaft wall, thereby achieving locking. When the system reaches a predetermined drilling height and drilling operation is required, the supporting claws 6 may extend and lock with the side wall(s) of the shaft, forming a reliable support to firmly fix the main frame 1 at the drilling height.

As shown in FIG. 1, the arrow direction of the Z-axis is upward, and the opposite direction of the arrow is downward. The supporting wheel 7 may be disposed either above or below the plurality of supporting claws 6, both achieving the same effect.

Exemplarily, the elastic component 8 is a combination of a spring and other connecting members. The other connecting members are used for connection to the supporting wheel 7, the floating plate 5, or the like. The elastic component 8 causes the supporting wheel 7 to press against the side wall of the shaft via its restoring force.

“Projection in the vertical direction” refers to a projection on the XY plane. The statement that under the driving of the elastic component 8, the projection of the supporting wheel 7 in the vertical direction is on the outer side of the projection of the plurality of supporting claws 6 in the vertical direction means that, on the projection on the XY plane, an outer edge of the supporting wheel 7 is closer to the side wall of the shaft compared to the supporting claws 6. When the supporting wheel 7 contacts the side wall of the shaft, it can provide elastic support before the supporting claws 6 do. When the system shakes or the side wall of the shaft is uneven, the distance between the side wall of the shaft and the main frame 1 may change. The elastic component 8 allows the supporting wheel 7 to adapt to changes in the distance between the side wall of the shaft and the main frame 1.

The electric push rod 11 may control the extension and retraction of the intermediate plate 4, thereby driving the entire supporting mechanism to move along the X-axis closer to or away from the side wall of the shaft, achieving the abutting function of the supporting wheel 7 and the locking function of the supporting claws 6. For example, the electric push rod 11 is a lead screw push rod driven by a motor. For example, the electric push rod 11 extends, pushing two intermediate plates 4 outward, thereby moving supporting wheels 7 and the supporting claws 6 closer to the side wall of the shaft on both sides of the to-be-machined surface. When the supporting wheels 7 abut against the shaft walls on both sides of the to-be-machined surface, the contact is elastic, which can prevent shaking. When the system reaches the drilling height, the supporting claws 6 are further extended via the electric push rod 11 to lock with the shaft walls on both sides of the to-be-machined surface, thereby fixing the position of the main frame 1.

In some embodiments, at least one sleeve assembly is arranged on the main frame 1. In some embodiments, the main frame 1 is provided with two sleeve assemblies, which are arranged on two sides of the electric push rod 11, respectively. Each sleeve assembly includes a sliding rod 12 and a sliding sleeve 13, an axis of the sliding rod 12 and an axis of the sliding sleeve 13 are parallel to an axis of the electric push rod 11, the sliding rod 12 is slidably connected to two ends of the sliding sleeve 13, and one end of the sliding rod 12 away from the sliding sleeve 13 is fixedly connected to the intermediate plate 4 on one of the supporting mechanisms.

As shown in FIG. 3, from the center of the main frame 1 towards the outer side, the arrangement is sequentially a first sleeve assembly, the electric push rod 11, and a second sleeve assembly. One end of the sliding rod 12 is slidably connected to the sliding sleeve 13, and the other end is fixedly connected to the intermediate plate 4.

When the electric push rod 11 pushes the intermediate plate 4, the intermediate plate 4 moves smoothly along a linear trajectory formed by the sliding rod 12 and the sliding sleeve 13, avoiding jamming or instability caused by lateral forces.

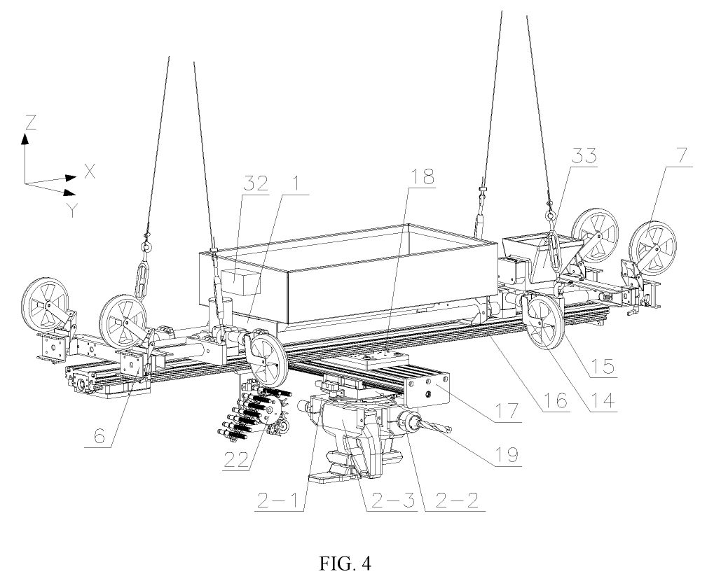

FIG. 4 is a schematic structural diagram of a suspended drilling and bolt mounting system of the present disclosure.

In some embodiments, as shown in FIG. 4, the wall supporting mechanism includes two wall supporting wheel assemblies arranged at intervals, and each wall supporting wheel assembly includes an L-shaped frame 14 and a wall supporting wheel 15. One end of the L-shaped frame 14 is rotatably connected to the wall supporting wheel 15, the other end of the L-shaped frame is rotatably connected to the main frame 1 along the horizontal direction, and a height of a rotation center of the wall supporting wheel 15 is lower than a height of a rotation center about which the L-shaped frame 14 rotates relative to the main frame 1.

As shown in FIG. 4, one end of the L-shaped frame 14 located below is rotatably connected to the wall supporting wheel 15, and the other end located above is rotatably connected to the main frame 1. The rotation axis of the wall supporting wheel 15 is parallel to the X-axis, and the rotation axis of the L-shaped frame 14 is parallel to the Y-axis. The rotation center of the L-shaped frame 14 is higher on the Z-axis than the rotation center of the wall supporting wheel 15.

When the main frame 1 descends into the shaft, the wall supporting wheel maintains contact with the to-be-machined surface. The wall supporting wheel is capable of 360-degree free rotation. Through the rotation of the wall supporting wheel itself, friction resistance can be reduced, ensuring the smooth descent of the main frame 1 and providing a certain degree of guidance and anti-collision function.

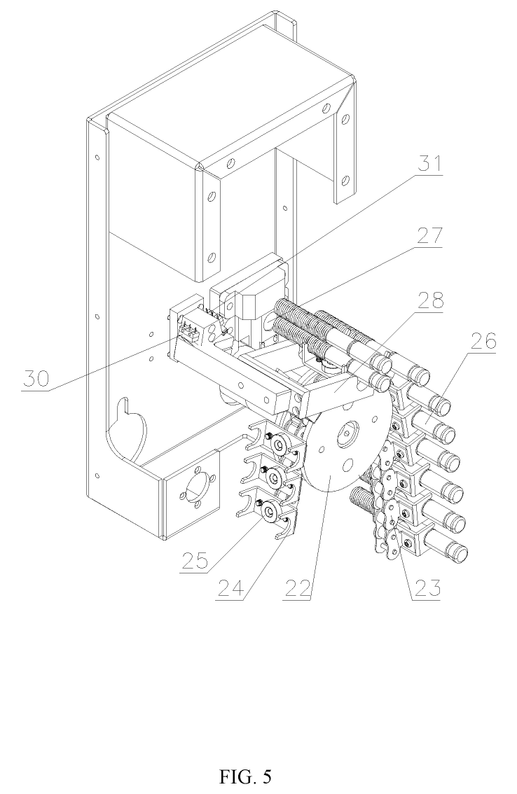

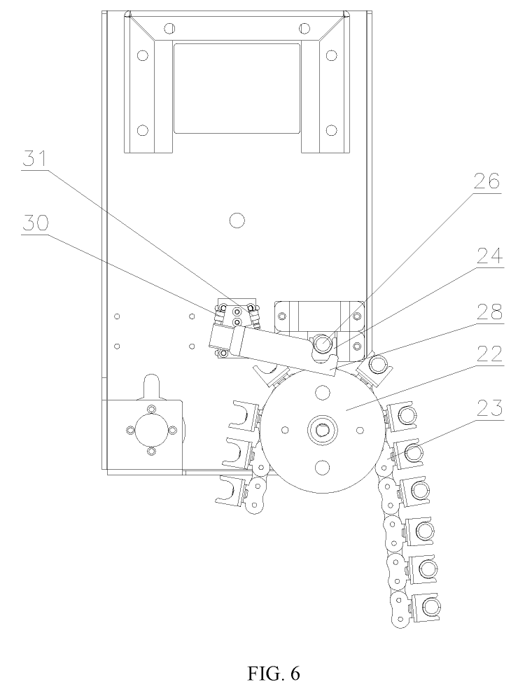

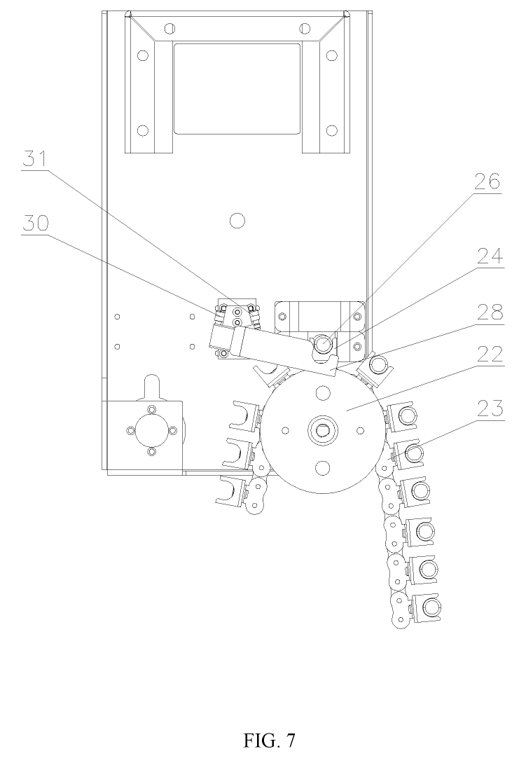

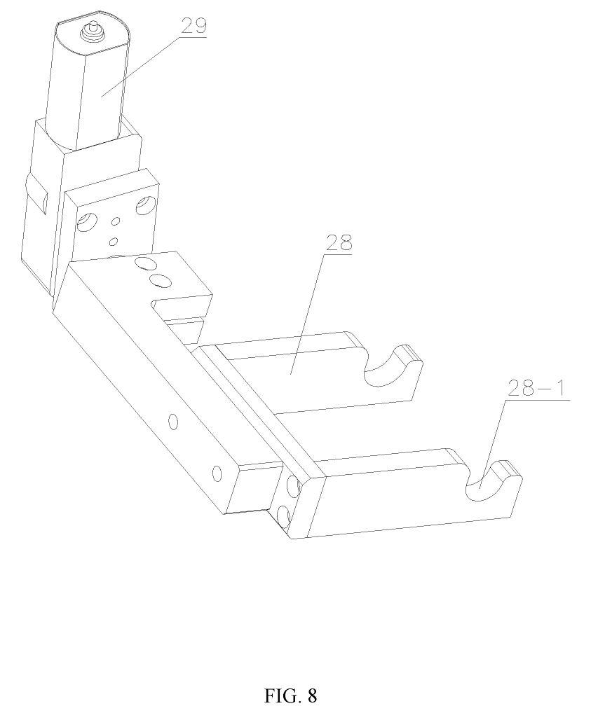

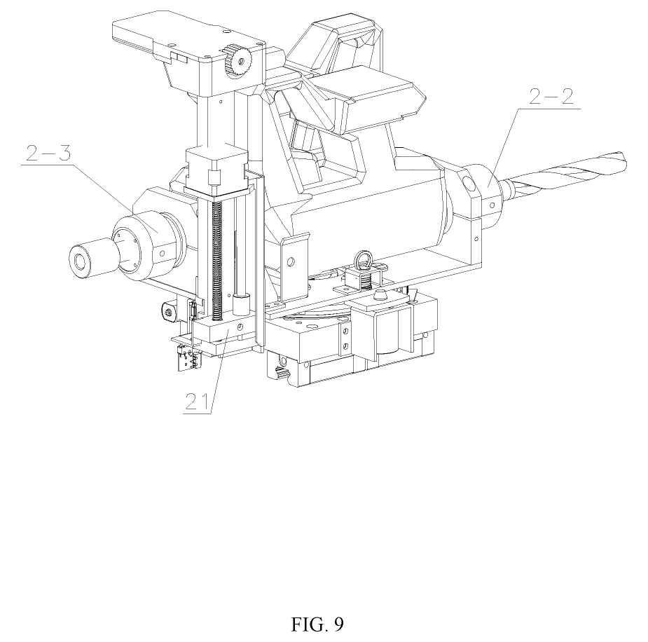

FIG. 5 is a schematic structural diagram of a bolt feeding assembly; FIG. 6 is a front view of a bolt feeding assembly; FIG. 7 is a side view of a bolt feeding assembly; FIG. 8 is a schematic structural diagram of a material shifting assembly; and FIG. 9 is a schematic structural diagram of a drilling and bolt mounting mechanism.

In some embodiments, as shown in FIG. 4 and FIG. 9, the drilling and bolt mounting mechanism 2 includes a machine frame 2-1 and a drill 2-2 and a knocking hammer 2-3 arranged on the machine frame 2-1, an axis of an output end of the drill 2-2 and an axis of an output end of the knocking hammer 2-3 are parallel to each other and arranged in opposite directions.

The drill 2-2 is used for drilling holes of a predetermined diameter and depth in the wall. The knocking hammer 2-3 is used for driving bolts 26 into the drilled holes or for grabbing the material shifting assembly of the bolts 26. The axis of the rotating shaft is parallel to the Z-axis. The third motor may drive the machine frame 2-1 to rotate about the axis of the rotating shaft, thereby adjusting the drill or the knocking hammer to a precise working angle. For example, when the drill is operating, the output end of the drill faces the to-be-machined surface; when it is necessary to strike a bolt, the machine frame 2-1 drives the drilling and bolt mounting mechanism 2 to rotate 180°, at which point the output end of the knocking hammer faces the to-be-machined surface. The axis of the output end of the drill 2-2 and the axis of the output end of the knocking hammer 2-3 are parallel to each other and arranged in opposite directions, ensuring that the knocking hammer 2-3 and the drill 2-2 do not interfere with each other during use.

In some embodiments, as shown in FIG. 4, the driving mechanism includes a first sliding rail 16, a second sliding rail 17, and a rotating shaft, the first sliding rail 16 is arranged below the main frame 1 along the X-axis, a first sliding block 18 is slidably connected to the first sliding rail 16, and a first lead screw and a first motor are arranged at one side of the first sliding rail 16 for driving the first sliding block 18 to slide back and forth along the X-axis. The second sliding rail 17 is arranged at a lower end of the first sliding block 18 along the Y-axis, a second sliding block 19 is slidably connected to the second sliding rail 17, and a second lead screw and a second motor are arranged at one side of the second sliding rail 17 for driving the second sliding block 19 to move back and forth along the Y-axis. The rotating shaft is arranged along the Z-axis, an upper end of the rotating shaft is rotatably connected to the second sliding block 19, a lower end of the rotating shaft is rotatably connected to the machine frame 2-1, and the second sliding block 19 is in transmission connection with a third motor used for controlling the machine frame 2-1 to rotate along the rotating shaft.

Rotatable connection may be achieved by means such as installing bearings. In some embodiments, the rotating shaft is arranged along the Z-axis, with its upper end rotatably connected to the second sliding block 19 and its lower end rotatably connected to the machine frame 2-1. The third motor is mounted on the second sliding block 19. An output end of the third motor is in transmission connection with the machine frame 2-1. For example, the output end of the third motor is provided with an external gear that meshes with an internal gear of the machine frame 2-1. The internal gear is rotatably onnected to the rotating shaft. The third motor drives the machine frame 2-1 to rotate about the axis of the rotating shaft. In other embodiments, the rotating shaft is arranged along the Z-axis, with its upper end rotatably connected to the second sliding block 19 and its lower end fixedly connected to the machine frame 2-1. The third motor is mounted on the second sliding block 19. The output end of the third motor is in transmission connection with the rotating shaft. The third motor drives the rotating shaft and the machine frame 2-1 to rotate about the axis of the rotating shaft.

The driving mechanism may achieve positioning and attitude adjustment of the drilling and bolt mounting mechanism. For example, by driving the first sliding block to move along the X-axis via the first motor, the drilling and bolt mounting mechanism may be moved to the X-coordinate of a predetermined drilling position. Then, by driving the second sliding block to move along the Y-axis via the second motor, the second sliding block may be moved to the Y-coordinate of the predetermined drilling position. Finally, by driving the rotating shaft and the machine frame to rotate about the Z-axis via the third motor, the drill or the knocking hammer may be adjusted to a suitable working angle.

In some embodiments, a rebar detector 21 is arranged on the machine frame 2-1, and the rebar detector 21 moves back and forth along the Z-axis driven by a lead screw motor assembly. The structure of the lead screw motor assembly controlling the rebar detector 21 to move back and forth along the Z-axis is similar to that of the first lead screw, the first motor, and the first sliding rail. The rebar detector 21 is used to detect whether there are reinforcing bars within the to-be-machined surface before drilling. The rebar detector 21 may employ an image acquisition device (such as a camera), ultrasonic or radar detection technology to obtain images of the to-be-machined surface, and determine the height of reinforcing bars within the to-be-machined surface through image recognition algorithms.

In some embodiments, a bolt feeding assembly is arranged on one side of the second sliding rail 17 away from the to-be-machined surface. The bolt feeding assembly includes a sprocket 22 and a chain 23. The sprocket 22 is in transmission connection with feeding motor 34. A rotation center of the sprocket 22 is arranged along the horizontal direction. The chain 23 is wound on the sprocket 22. A plurality of feeding units are arranged on an outer wall surface of the chain 23 at intervals, and each feeding unit includes two bolt clamping plates 24 which are oppositely arranged. Each of a plurality of bolts 26 is clamped at an inner axial position defined by the two bolt clamping plates 24, and an axis of each of the plurality of bolts 26 is parallel to an axis of the sprocket 22. A magnet 25 is disposed between the two bolt clamping plates 24 of each of the plurality of feeding units for attracting one of the plurality of bolts 26. A feeding in-place switch 27 is arranged on one side of a highest point of the sprocket 22 for monitoring one of the plurality of bolts 26, and a material shifting assembly is arranged on one side of the feeding in-place switch 27 for shifting one of the plurality of bolts 26 out of the two bolt clamping plates 24 so that the knocking hammer 2-3 is capable of grabbing the plurality of bolts 26. The sprocket 22 is in transmission connection with a feeding motor 34. The feeding motor 34 is used to drive the sprocket 22 to rotate, thereby causing the feeding units on the chain 23 to transport the bolts.

As shown in FIG. 4, the axis of the sprocket 22 and the axis of each bolt 26 are parallel to the Y-axis. The chain 23 may rotate along the contour of the sprocket 22. The two bolt clamping plates 24 which are oppositely arranged are sequentially arranged along the Y-axis. Each of the bolt clamping plates 24 are provided with a U-shaped notch. An inner axis of the two bolt clamping plates 24 is a connecting line between center points of the two U-shaped notches. The highest point of the sprocket 22 refers to its highest point on the Z-axis.

In some embodiments, the material shifting assembly includes two material shifting plates 28 arranged in parallel and a material shifting motor 29. An axis of an output end of the material shifting motor 29 is parallel to the axis of the sprocket 22. The two material shifting plates 28 are arranged at the output end of the material shifting motor 29. The two material shifting plates 28 are arranged at two sides of the sprocket 22, respectively, and each material shifting plate 28 is provided with an arc-shaped groove 28-1 matched with the bolts 26.

As shown in FIG. 5 to FIG. 8, the two material shifting plates 28 are respectively disposed on two axial sides of the sprocket 22. The two material shifting plates 28 are located between the feeding in-place switch 27 and the axis of the sprocket 22 on the Z-axis.

In some embodiments, one side of the material shifting motor 29 is provided with a material shifting initial position switch 30 and a material shifting in-place switch 31. When one of the two material shifting plates 28 is in contact with the material shifting initial position switch 30, the arc-shaped groove 28-1 is arranged below the feeding in-place switch 27, and when one of the two material shifting plates 28 is in contact with the material shifting in-place switch 31, the arc-shaped groove 28-1 is arranged above the feeding in-place switch 27. For example, the inner material shifting plate 28 among the two material shifting plates is used to contact the material shifting initial position switch 30 and the feeding in-place switch 27. The feeding in-place switch 27 and the material shifting initial position switch 30 may be photoelectric sensors (e.g., infrared sensors), limit switches, or the like.

In some embodiments, the suspended drilling and bolt mounting system further includes a measuring mechanism, where the measuring mechanism includes a plurality of distance sensors 32, a controller, and a laser plummet 33 arranged on the main frame 1, and the plurality of distance sensors 32, the laser plummet 33, the first motor, the second motor, and the third motor are all in circuit connection with the controller.

The distance sensor 32 is used to measure a distance between the main frame 1 and the shaft wall. The controller includes a Programmable Logic Controller (PLC), a Central Processing Unit (CPU), or the like. The laser plummet 33 is used to detect whether the system is in a counterweight status.

In some embodiments, the working process of the suspended drilling and bolt mounting system is as follows.

The system is controlled to enter the shaft by the winch and the slings 3, the two wall supporting wheels 15 on the main frame 1 pressed the to-be-machined surface in the shaft, the electric push rod 11 on the two sides of the main frame 1 extend out, and the two intermediate plates 4 are pushed out towards the two sides, so that the supporting wheel 7 and the supporting claws 6 are driven to get close to the side walls of the shaft on the two sides of the to-be-machined surface. When the supporting wheel 7 abuts against the side wall of the shaft, and the supporting claws 6 are not in contact with the side wall of the shaft, under the action of a spring hinge, the supporting wheel 7 is elastic in contact with the side wall of the shaft, so that the system can move up and down freely, and meanwhile, the system is prevented from shaking greatly in the shaft.

When the system reaches the drilling position, whether the rebar exists in the to-be-machined surface or not is detected by the rebar detector 21, and if the rebar exists, the slings 3 and the winch need to adjust the height of the system again, so that the system is in the counterweight status again. When the system is in the counterweight status in the shaft, the system is always perpendicular to the ground, and in the counterweight status, the distance sensors 32 measure the distance between the system and the side wall of the shaft for the first time. Then the supporting claws 6 are extended out to be locked with the side walls on the two sides, and in this case, the distance sensors 32 measure the distance between the system and the side wall of the shaft for the second time. The difference between the second measurement and the first measurement is calculated by the controller, and the difference is compensated to the drill 2-2. The first motor, the second motor, and the third motor on the driving mechanism work with each other to adjust the position of the drill 2-2, so as to ensure that the hole drilled by the drill 2-2 is perpendicular to the to-be-machined surface.

After drilling, the bolt 26 is fed by the sprocket 22 and the chain 23. When the feeding in-place switch 27 detects that the bolt 26 is in place, the feeding motor 34 on the sprocket 22 stops rotating, the material shifting motor 29 drives the material shifting plate 28 to rotate, and the bolt 26 in the bolt clamping plates 24 is shifted out in the rotating process of the material shifting plate 28. When the material shifting in-place switch 31 senses the material shifting plate 28, the material shifting plate 28 stops rotating, and in this case, the knocking hammer 2-3 approaches and removes the bolt 26 on the material shifting plate 28, and the material shifting motor 29 drives the material shifting plate 28 to rotate reversely. When the material shifting initial position switch 30 senses the material shifting plate 28, the material shifting plate 28 stops rotating, and waits for the sprocket 22 to send a next bolt 26 to the feeding in-place switch 27, and so on, the automatic feeding of the bolts 26 is completed.

The controller adjusts the position of the knocking hammer 2-3 by working together with the first motor, the second motor, and the third motor on the driving mechanism. After the bolt 26 is removed by the knocking hammer 2-3, the bolt 26 on the knocking hammer 2-3 is hammered into the hole drilled by the drill 2-2.

Direction and references (e.g., up, down, left, right, etc.) in the present disclosure may be used only to assist in the description of the features in the accompanying drawings. Therefore, the following specific embodiments are not used in a limiting sense, and the scope of the claimed subject matter is defined only by the appended claims and their equivalents.

The foregoing ideal embodiment according to the present disclosure is used as an inspiration, and through the above description, those skilled in the art will be able to make various changes and modifications without departing from the scope of the present disclosure. The technical scope of the present disclosure is not limited to the content in the description, and the technical scope of the present disclosure must be determined according to the scope of the claims.

What is claimed is:

1. A suspended drilling and bolt mounting system, comprising a main frame, wherein a plurality of slings used for controlling lifting of the main frame are arranged above the main frame, two supporting mechanisms are arranged on two sides of the main frame in a length direction, respectively, the two supporting mechanisms are used for limiting a shaking amplitude of the main frame in a lifting process, the two supporting mechanisms are further used for fixing a position of the main frame during drilling and bolt mounting of the suspended drilling and bolt mounting system, a wall supporting mechanism matched with a side wall of a shaft is arranged on a side, close to a to-be-machined surface, of the main frame, a drilling and bolt mounting mechanism is arranged below the main frame, and a driving mechanism used for driving the drilling and bolt mounting mechanism to move along an X-axis, move along a Y-axis, and rotate along a Z-axis is arranged between the main frame and the drilling and bolt mounting mechanism;
the drilling and bolt mounting mechanism includes a machine frame and a drill and a knocking hammer arranged on the machine frame, an axis of an output end of the drill and an axis of an output end of the knocking hammer are parallel to each other and arranged in opposite directions; and
the driving mechanism includes a second sliding rail, a bolt feeding assembly is arranged on one side of the second sliding rail away from the to-be-machined surface, the bolt feeding assembly includes a sprocket and a chain, a rotation center of the sprocket is arranged along a horizontal direction, the chain is wound on the sprocket, a plurality of feeding units are arranged on an outer wall surface of the chain at intervals, each of the plurality of feeding units includes two bolt clamping plates which are oppositely arranged, each of a plurality of bolts is clamped at an inner axial position defined by the two bolt clamping plates, and an axis of each of the plurality of bolts is parallel to an axis of the sprocket, a magnet is disposed between the two bolt clamping plates of each of the plurality of feeding units for attracting one of the plurality of bolts, a feeding in-place switch is arranged on one side of a highest point of the sprocket for monitoring one of the plurality of bolts, and a material shifting assembly is arranged on one side of the feeding in-place switch for shifting one of the plurality of bolts out of the two bolt clamping plates so that the knocking hammer is capable of grabbing the plurality of bolts.

2. The suspended drilling and bolt mounting system according to claim 1, wherein each of the two supporting mechanism includes an intermediate plate and a floating plate, the floating plate is arranged on one side of the intermediate plate away from the main frame, a middle position of the floating plate is hinged to the intermediate plate along a vertical direction, a limiting spring used for limiting a swing amplitude of the floating plate is arranged on the intermediate plate, the limiting spring is arranged between the floating plate and the intermediate plate, a plurality of supporting claws are arranged at two ends of a side wall of the floating plate away from the intermediate plate, a supporting wheel is arranged above or below each of the plurality of supporting claws, an elastic component is arranged between the supporting wheel and the floating plate, under driving of the elastic component, a projection of the supporting wheel in the vertical direction is on an outer side of a projection of the plurality of supporting claws in the vertical direction, and the main frame is provided with an electric push rod used for pushing intermediate plates of the two supporting mechanisms towards two sides of the main frame.

3. The suspended drilling and bolt mounting system according to claim 2, wherein the intermediate plate and the floating plate are both U-shaped plates, an inner diameter of the floating plate is larger than an outer diameter of the intermediate plate, the intermediate plate partially extends into a U-shaped groove of the floating plate, a U-shaped connecting frame is arranged on an outer side of the intermediate plate, and a connecting pin matched with the floating plate is vertically arranged in the U-shaped connecting frame.

4. The suspended drilling and bolt mounting system according to claim 2, wherein at least one sleeve assembly is arranged on the main frame, each of the at least one sleeve assembly includes a sliding rod and a sliding sleeve, an axis of the sliding rod and an axis of the sliding sleeve are parallel to an axis of the electric push rod, the sliding rod is slidably connected to two ends of the sliding sleeve, and one end of the sliding rod away from the sliding sleeve is fixedly connected to the intermediate plate on one of the two supporting mechanisms.

5. The suspended drilling and bolt mounting system according to claim 1, wherein the wall supporting mechanism includes two wall supporting wheel assemblies arranged at intervals, each of the two wall supporting wheel assemblies includes an L-shaped frame and a wall supporting wheel, one end of the L-shaped frame is rotatably connected to the wall supporting wheel, the other end of the L-shaped frame is rotatably connected to the main frame along the horizontal direction, and a height of a rotation center of the wall supporting wheel is lower than a height of a rotation center about which the L-shaped frame rotates relative to the main frame.

6. The suspended drilling and bolt mounting system according to claim 1, wherein the driving mechanism includes a first sliding rail, the second sliding rail, and a rotating shaft, the first sliding rail is arranged below the main frame along the X-axis, a first sliding block is slidably connected to the first sliding rail, a first lead screw and a first motor are arranged at one side of the first sliding rail for driving the first sliding block to slide back and forth along the X-axis, the second sliding rail is arranged at a lower end of the first sliding block along the Y-axis, a second sliding block is slidably connected to the second sliding rail, a second lead screw and a second motor are arranged at one side of the second sliding rail for driving the second sliding block to move back and forth along the Y-axis, the rotating shaft is arranged along the Z-axis, an upper end of the rotating shaft is rotatably connected to the second sliding block, a lower end of the rotating shaft is rotatably connected to the machine frame, and the second sliding block is in transmission connection with a third motor for controlling the machine frame to rotate along the rotating shaft.

7. The suspended drilling and bolt mounting system according to claim 6, wherein a rebar detector is arranged on the machine frame, and the rebar detector is provided with a lead screw motor assembly used for controlling the rebar detector to move back and forth along the Z-axis.

8. The suspended drilling and bolt mounting system according to claim 1, wherein the material shifting assembly includes two material shifting plates arranged in parallel and a material shifting motor, an axis of an output end of the material shifting motor is parallel to the axis of the sprocket, the two material shifting plates are arranged at the output end of the material shifting motor, the two material shifting plates are arranged at two sides of the sprocket, respectively, and each of the two material shifting plates is provided with an arc-shaped groove matched with the plurality of bolts.

9. The suspended drilling and bolt mounting system according to claim 8, wherein one side of the material shifting motor is provided with a material shifting initial position switch and a material shifting in-place switch, when one of the two material shifting plates is in contact with the material shifting initial position switch, the arc-shaped groove is arranged below the feeding in-place switch, and when one of the two material shifting plates is in contact with the material shifting in-place switch, the arc-shaped groove is arranged above the feeding in-place switch.

10. The suspended drilling and bolt mounting system according to claim 6, further comprising a measuring mechanism, wherein the measuring mechanism includes a plurality of distance sensors, a controller, and a laser plummet arranged on the main frame, and the plurality of distance sensors, the laser plummet, the first motor, the second motor, and the third motor are all in circuit connection with the controller.
